(19) United States
(12) Patent Application Publication
(10) Pub. No.: US 2006/0017702 A1
(43) Pub. Date: Jan. 26, 2006

(54) Touch control type character input method and control module thereof

(76) Inventor: Chung-Yi Shen, Taipei (TW)

Correspondence Address: G. LINK CO., LTD., 3550 BELL ROAD, MINOOKA, IL, 60447, US

(21) Appl. No.: 10/896,956

(22) Filed: Jul. 23, 2004

(51) Int. Cl. G09G 5/00

(52) U.S. Cl. 345/173

(57) ABSTRACT

A touch control type character input method is to utilize a control module for identifying moving loci created by an object moving on a hand writing board so as to be used during subsequent input. A plurality of vectors, which move in different directions, are combined and a parameter data collection is defined in the control module. When the object contacts the hand writing board, the position of the hand writing board being first touched is detected and assigned as the initial position. Then, a moving locus generated on the hand writing board is determined if it is effective and the moving locus is disassembled as at least a moving vector in case of being effective and is removed in case of being ineffective. The obtained moving vectors are combined and analyzed and compared with the parameter data collection defined in the control module. A compared result is output if the combined moving vectors are in accordance with the parameter data collection

### BACKGROUND OF THE INVENTION

1. Field of the Invention

The present invention is related to a touch control type character input method and control module thereof and particularly to a touch control type character input method and control module thereof with which moving locus combination defined with an initial position and moving directions for being available for character input.

2. Brief Description of Related Art

The current touch pad can be classified into capacitance type, resistance type, electromagnetic type, pressure type,. Inductance type, surface sound wave type, supersonic type and optical type based on the physical principle of detecting touch control point. Ordinarily, the resistance type and capacitance type touch pads are frequently seen at the present time and they are primarily used in consumed electronic products such as notebook computers, flat computers, personal digital assistants and etc. A stylus or a finger is utilized to move on the touch pad for inputting characters by way of hand writing or simulating click function of a mouse.

As for the input method of a touch pad, a relative coordinate mode, which utilizes a distance between relative locations to control cursor movement of the mouse or a absolute coordinate mode, which provides plotting and hand writing functions for the user, are used. For recognition of the hand writing input function, taking U.S. Pat. No. 4,284,975 as an example, the prior art discloses a coordinate difference between a hand writing character point and a reference character point is calculated for recognizing the character. The main idea thereof is to figure out measured value of the distance between point and point and the way to find out the difference is to calculate the relative displacement of coordinates corresponding to moving locus of hand writing. However, it is very complicated to operate measured value of distance between a point and another point.

### SUMMARY OF THE INVENTION

An object of the present invention is to provide a touch control type character input method, which can define a moving locus by way of an initial position and moving directions easily, to overcome the deficiency of the prior art, which has to treat extremely complicated calculation.

Hence, a touch control type character input method according to the present invention has a control module to identify loci created by an object moving on a hand writing board and to generate a control signal corresponding to a combination of different ones of the moving loci for being used by a host unit performing subsequent input and the method includes following steps: combining moving vectors in different directions and a parameter data collection available for comparison being defined in the control module; detecting a position, which is touched by the object at the first time on the hand writing board, and assigning the position as an initial position; determining if a moving locus created on the hand writing board is effective and disassembling the effective moving locus as at least one of the moving vectors and removing ineffective moving locus; combining the obtained moving vectors and after the object detaches the hand writing board a period of time duration, analyzing the obtained and combined moving vectors, comparing the combined moving vectors with the parameter data collection defined in the control module and outputting a compared result in case of the combined moving vectors being in accordance with the parameter data collection.

A control module according to the present invention is electrically connected to the hand writing board and a host unit for identifying a plurality of different moving loci created by an object moving on the hand writing board and to generate a control signal corresponding to a combination of different ones of the moving loci for being used by the host unit performing subsequent input. Wherein, a coordinate treating unit is electrically connected to the hand writing board for receiving the moving loci on the hand writing board and transforming the moving loci to a plurality of corresponding coordinate parameters; a memory unit is preset with an internal parameter data collection for being available for comparison; an operation unit is electrically connected to the coordinate treating unit and the memory unit, assigns a position being first touched on the hand writing board as an initial position, takes the initial position and the moving loci in the different directions as judging criterion, disassembles the coordinate parameters received with the coordinate treating unit into moving vectors and combining the moving vectors, compares the moving vectors with parameters saved in the parameter data collection and outputs a control signal corresponding the character; a transmission interface is electrically connected to the host unit and the operation unit and transmits the control signal generated by the operation.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a plan view of a preferred embodiment of a touch control type character input method according to the present invention illustrating a first touching position of a finger being looked upon as the initial position P1 and a movement being determined as effective controlled movement in case of the finger moving in a certain angular range;

FIG. 2 is a plan view illustrating the displacement S′ being determined as an ineffective controlled movement due to value of the displacement S′ being too small to reach a preset distance and the subsequent displacement S being determined as an effective controlled movement due to value of the displacement S exceeding the preset distance;

FIG. 3 is a diagram illustrating vectors moving along different directions defining a parameter information collection for comparison;

FIG. 4 is a diagram illustrating combination states meeting various moving vectors while characters “1”, “2”, “A” and “B” are taken as examples and written down;

FIG. 5 is a block diagram of circuit illustrating control module of the present invention; and

FIG. 6 is a flow chart illustrating executed steps of the touch control type character input method.

### DETAILED DESCRIPTION OF THE PREFERRED EMBODIMENTS

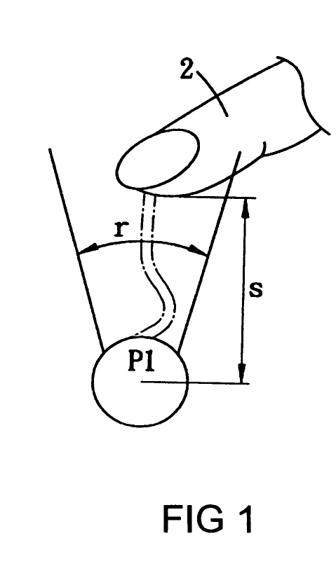

Referring to FIG. 1, a preferred embodiment of touch control type character input method according to the present invention is illustrated. A position on a writing board (not shown) being touched by a finger 2 or object at the first time is assigned as the initial position P1. As long as the finger 2 or object touches the surface of the writing board at the first time, the touched position is looked upon as the initial position. Further, a control signal can be output continuously during the finger 2 or object moving on the writing board exceeding preset time duration in the system and the signal output stops in case of the finger 2 or object being apart from the writing board.

It is noted that there is no restriction to what location of the initial position P1 has to be on the writing board and a movement starting from the initial position P1 toward any one of the longitudinal direction, transverse direction and an inclining direction within an angular range between 15° and 60° can be looked upon as an effective controlled movement. Further, the displacement S done by the finger or object on the writing board is detected and if the displacement S exceeds a preset distance, the movement is determined as the effective controlled movement.

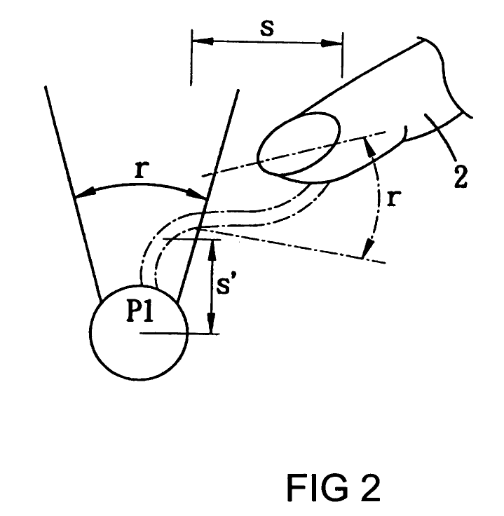

Referring to FIG. 2, if the displacement S′, which is also done by the finger or object on the writing board, is too small to reach to the preset distance, the movement is determined as an ineffective controlled movement. Nevertheless, the displacement S, which follows the displacement S′, exceeds the preset distance and an effective controlled movement can be determined and the system performs subsequent recognition and treatment.

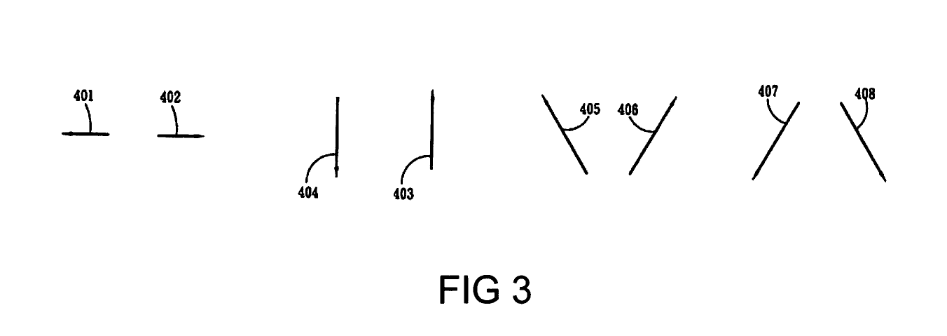

Referring to FIG. 3, the touch control type character input method according to the present invention in company with the moving vectors 401˜408 from different moving directions such as a longitudinal, a transverse and an inclining directions can be combined and defined a parameter data collection. The moving vectors are defined as moving vector 401 being along the left direction, moving vector 402 being along right direction, moving vector 403 being along upward direction, moving vector 404 being along downward direction, moving vector 405 along northwest direction, moving vector 406 being along northeast direction, moving vector 407 being along southwest direction and moving vector 408 being along southeast direction. It is noted that the moving vectors can be desirably defined as other suitable angles and directions without being limited with the preceding eight directions.

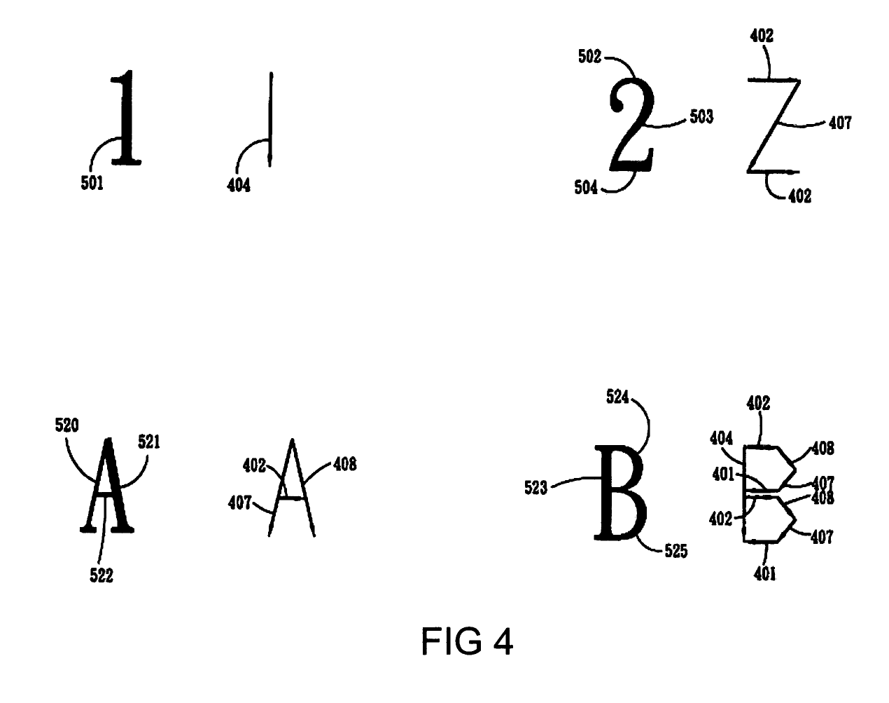

Referring to FIG. 4 in company with FIG. 3 again, taking writing a digit “1” as an example, when the system has analyzed a moving locus 501 during moving and the moving locus 501 is in accordance with the moving vector 404 stored in the parameter data collection, the digit “1” is read and output. Taking writing digit “2” as another example, when the system has analyzed and disassembled loci 502˜504 during moving and the loci 502˜504 are in accordance with the combination of the moving vectors 402, 407 and 402, the combination of the moving vectors 402, 407 and 402 is read and output Taking writing an alphabet “A” as example, when the system has analyzed and disassembled loci 520˜522 during moving and the loci 520˜522 are in accordance with a combination of the moving vectors 407, 408 and 402 stored in the parameter data collection, the combination of the moving vectors 407, 408 and 402 is read and the letter “A” is output. Taking writing an alphabet “B” as an example, when the system has analyzed and disassembled loci 523˜525 during moving and the loci 523˜525 are in accordance with a combination of the moving vectors 401, 402, 407 and 408 stored in the parameter data collection, the combination of the moving vectors 401, 402, 407, 408 is read and the letter “B” is output. As for other characters or symbols can be recognized with the preceding way.

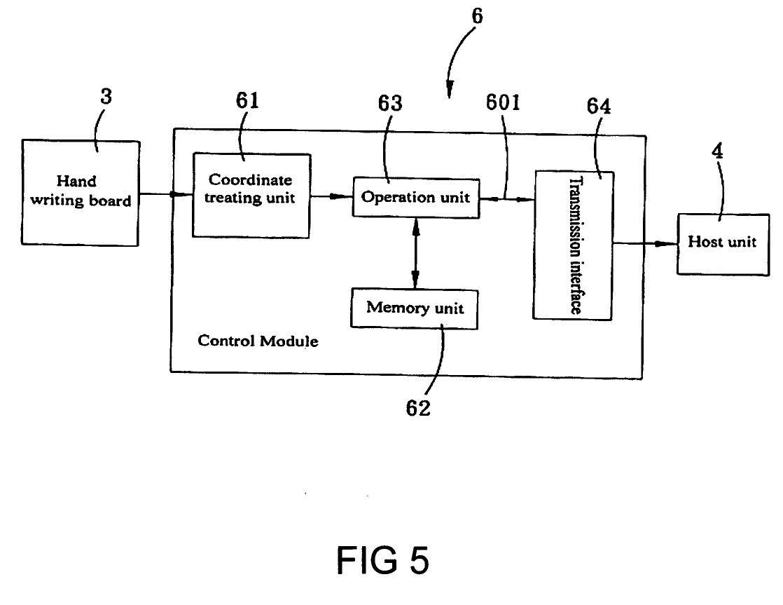

Referring to FIG. 5, a control module 6 of the present invention is illustrated. The control module 6 is electrically connected to a coordinate treating unit 61 of the hand writing board 3, a memory unit 62 with internal preset parameter data collection for comparison, an operation unit 63 being disposed between and electrically to the coordinate treating unit 61 and the memory unit 62 and a transmission interface 64 is disposed between and electrically connected to the operation unit 63 and a host unit 4.

Wherein, the hand writing board 3 can be an ordinary capacitance type, resistance type, electromagnetic type, pressure type, inductance type, surface sound wave type, supersonic type or an optical touch device. The host unit 4 can be an electronic device installed with character input software such as a computer, a cell phone or a personal digital assistant. The coordinate treating unit 61 is used for receiving loci of the finger 2 or object during moving and transforming the loci to corresponding coordinate parameters 501. The operation unit 63 is used for assigning position of the hand writing board 3 being touched at the first time as the initial position P1, transforming the coordinate parameter received from the coordinate treating unit to moving vectors, filtering out ineffective moving loci, taking the initial position P1 together with effective moving vectors as judging criterion and comparing combinations of moving vectors of the parameter data collection stored in the memory unit 62 in advance and outputting control signal 601 corresponding to the gesture. The transmission interface 64 transforms the control signal 601 generated by the operation unit 63 to that can be recognized and used by the host unit 4.

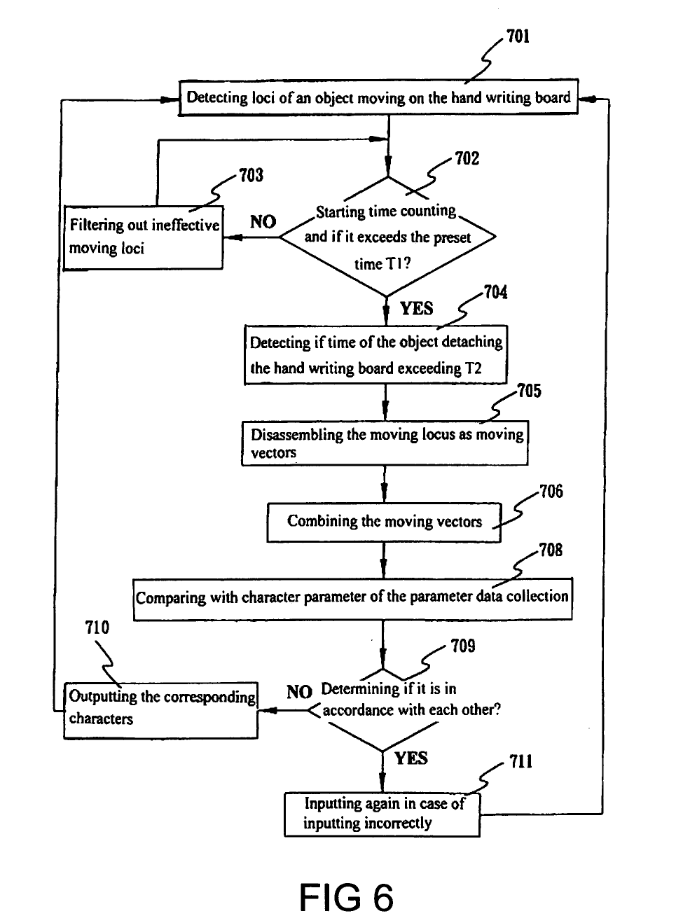

Referring to FIG. 6, the executing process of the touch control type input method according to the present invention is illustrated. Step 701 is to detect a locus of an object moving on the hand writing board and assign a position of the hand writing board being touched at the first time as the initial position. Then, step 702 is to count time duration and check if the time duration exceeds a preset time T1 and step 703 is executed if the time duration is within the preset time T1. Step 703 is to filter out ineffective locus moved by the object on the hand writing board and if the time duration exceeds the preset time T1 and step 704 is executed to detect and make sure time duration of the object not touching the hand writing board exceeding T2 and it is affirmed that input of a character has been done. Step 705 is then executed to disassemble the locus into different vectors and step 706 is to arrange the vectors as different combinations. Step 708 is to compare with character parameter in the parameter data collection stored in advance. Step 709 is to determine if the character parameter in the parameter data collection stored in advance is in accordance with the combination vectors. In case of it is in accordance with each other, step 710 is executed to output the corresponding character and in case of it is not in accordance with each other, step 711 is executed to determine the input being incorrect and another input has to be performed. If next character input is input, steps 701˜711 are repeated.

It is appreciated that the touch control type character input method according to the present invention is mainly performed by the control module 6 to assign the position of the first touch to the hand writing board 3 as the initial position P1, to transform the received coordinate parameter to moving vectors, to filter out ineffective moved locus, to take the initial position P1 and the effective moving vectors as judging criterion, to compare with character parameter of the parameter data collector saved in the memory unit 62 in advance and finally to output control signal 601 corresponding to the gesture. Hence, comparing to conventional way, which is to figure out coordinate difference between character points and reference point, the touch control type character input method of the present invention, which defines moved locus by way of the initial position and moving direction, is treated more easily and more conveniently and problems of complicated operation during the conventional input method being treated can be solved completely.

While the invention has been described with referencing to preferred embodiments thereof, it is to be understood that modifications or variations may be easily made without departing from the spirit of this invention, which is defined by the appended claims.

What is claimed is:

1. A touch control type character input method, which has a control module to identify a plurality of moving loci created by an object moving on a hand writing board and to generate a control signal corresponding to a combination of different ones of the moving loci for being used by a host unit performing subsequent input, comprising following steps:
A) combining a plurality of moving vectors in different directions and a parameter data collection available for comparison being defined in the control module;
B) detecting a position, which is touched by the object at the first time on the hand writing board, and assigning the position as an initial position;
C) determining if a moving locus created on the hand writing board is effective and disassembling the moving locus as at east one of the moving vectors in case of the moving locus being effective and removing the moving locus in case of the moving locus being ineffective;
D) combining the moving vectors obtained in step (C) and processing step (E) after the object detaches the hand writing board a period of time duration; and
E) analyzing the obtained and combined moving vectors, comparing the arranged moving vectors with the parameter data collection defined in the control module and outputting a compared result in case of the combined moving vectors being in accordance with the parameter data collection.

2. The touch control type character input method as defined in claim 2, wherein a way for determining if the a moving locus created on the hand writing board is effective in step C) is the moving locus being within a specific angular range with respect to the initial position, which is taken as a rotational center of the angular range.

3. The touch control type character input method as defined in claim 2, wherein the angular range is between 15° to 60°.

4. The touch control type character input method as defined in claim 2, wherein a displacement, which is caused by the object moving on the hand writing board, being detected and determined as effective if the displacement exceeds a preset distance is processed in step C.

5. The touch control type character input method as defined in claim 1, wherein the moving vectors defined in step A move along one of longitudinal direction, a transverse direction and an inclining direction.

6. A control module, which is electrically connected to a hand writing board and a host unit for identifying a plurality of different moving loci created by an object moving on the hand writing board and to generate a control signal corresponding to a combination of different ones of the moving loci for being used by the host unit performing subsequent input, comprising:
a coordinate treating unit, being electrically connected to the hand writing board for receiving the moving loci on the hand writing board and transforming the moving loci to a plurality of corresponding coordinate parameters;
a memory unit, being preset with an internal parameter data collection for being available for comparison;
an operation unit, being electrically connected to the coordinate treating unit and the memory unit, assigning a position being first touched on the hand writing board as an initial position, taking the initial position and the moving loci in the different directions as judging criterion, disassembling the coordinate parameters received with the coordinate treating unit into moving vectors and combining the moving vectors, comparing the moving vectors with parameters saved in the parameter data collection and outputting a control signal corresponding the character;
a transmission interface, being electrically connected to the host unit and the operation unit and transmitting the control signal generated by the operation.

7. The control module as defined in claim 6, wherein the moving vectors defined by the parameter data collection move along one of a longitudinal direction, a transverse direction and an inclining direction.
